(19) United States
(12) Patent Application Publication
(10) Pub. No.: US 2026/0270043 A1
(43) Pub. Date: Sep. 10, 2026

(54) CAYLEY HASH FUNCTION WITH COOKIE-BASED STATE TRANSITIONS

(71) Applicant: Research Foundation of the City University of New York, New York, NY (US)

(72) Inventors: Bianca Sosnovski, Hempstead, NY (US); Vladimir Shpilrain, New York, NY (US); Alina Vdovina, New York, NY (US)

(21) Appl. No.: 19/556,597

(22) Filed: Mar. 4, 2026

Related U.S. Application Data
(60) Provisional application No. 63/766,528, filed on Mar. 4, 2025.

(51) Int. Cl. H04L 9/06

(52) U.S. Cl. CPC H04L 9/0643

(57) ABSTRACT

A method for cryptographic hashing includes receiving an input bit string and initializing a cookie state to inactive. For each bit processed sequentially, the method includes determining whether the bit is zero or one, selecting generator matrix A when the bit is zero, selecting generator matrix B when the bit is one and the cookie state is inactive, and selecting generator matrix C when the bit is one and the cookie state is active. The method includes multiplying a cumulative hash matrix by the selected generator matrix, activating the cookie state upon detecting a first predetermined bit pattern, deactivating it upon detecting a second predetermined bit pattern, and outputting the updated cumulative hash matrix as a hash value. Matrices A, B, and C are over a finite field.

### CROSS-REFERENCE TO RELATED APPLICATIONS

This application claims priority to U.S. Application No. 63/766,528, titled CAYLEY HASH FUNCTIONS FOR ENHANCED DATA SECURITY, filed Mar. 4, 2025, which is hereby incorporated by reference in its entirety.

### FIELD OF INVENTION

The present disclosure relates to cryptographic hash functions, and more particularly to Cayley-graph-based hash constructions employing cookie-based state transitions on a three-generator semigroup of matrices over a finite field for enhanced preimage resistance and collision resistance in data security applications.

### BACKGROUND

Hash functions are compression functions that convert variable-length inputs into fixed-length outputs and are widely used as compact digital fingerprints to ensure data integrity. They play a fundamental role in applications such as digital signatures, password hashing, file-integrity verification, blockchain technology, and message-authentication codes, where a change to underlying data must be detectable.

A particular family of hash function designs, known as Cayley hash functions, generates hash values by assigning a matrix to each bit of an input string and multiplying the selected matrices or semigroup elements corresponding to the bits of an input string. In these schemes, hashing proceeds from left to right, and the sequence of matrix multiplications can be viewed as a walk along the edges of a Cayley graph generated by the chosen matrices. Although this algebraic framework is appealing, earlier Cayley hash constructions that rely on only two generator matrices have shown practical weaknesses, and several have been successfully attacked through collision-finding and preimage-finding techniques. These results demonstrate that traditional two-generator Cayley hashing does not always provide the level of security required for modern cryptographic applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for cryptographic hashing is provided. The method includes receiving, by a processor, an input bit string. The method includes initializing a cookie state to an inactive state. The method includes, for each bit in the input bit string processed sequentially from left to right: determining whether the bit is a zero bit or a one bit; when the bit is a zero bit, selecting a first generator matrix A; when the bit is a one bit and the cookie state is inactive, selecting a second generator matrix B; when the bit is a one bit and the cookie state is active, selecting a third generator matrix C; multiplying a cumulative hash matrix by the selected generator matrix to produce an updated cumulative hash matrix; activating the cookie state upon detecting three consecutive one bits in the input bit string; and deactivating the cookie state upon detecting three consecutive zero bits in the input bit string. The method includes outputting the updated cumulative hash matrix as a hash value of the input bit string. The first generator matrix A, the second generator matrix B, and the third generator matrix C are 2×2 matrices over a finite field [symbol] where p is a prime number.

According to other aspects of the present disclosure, the method may include one or more of the following features. The first generator matrix A may be defined as

$$A = ( \begin{matrix}1 & 2 \\ 0 & 1\end{matrix} ) ,$$

the second generator matrix B may be defined as

$$B = ( \begin{matrix}1 & 0 \\ 2 & 1\end{matrix} ) ,$$

and the third generator matrix C may be defined as

$$C = ( \begin{matrix}2 & 1 \\ 1 & 1\end{matrix} ) .$$

The prime number p may be a 256-bit prime. The first generator matrix A, the second generator matrix B, and the third generator matrix C may generate a free semigroup over integers. The method may further include dividing the input bit string into a plurality of chunks at boundaries where three consecutive zero bits occur, computing a partial hash matrix for each chunk in parallel, and combining the partial hash matrices through matrix multiplication to produce the hash value. The hash value may have a size of 1024 bits when the prime number p is a 256-bit prime. Multiplying the cumulative hash matrix by the selected generator matrix may be performed using addition operations without multiplication operations in [symbol] .

According to another aspect of the present disclosure, a system for cryptographic hashing is provided. The system includes a memory storing instructions. The system includes a processor coupled to the memory and configured to execute the instructions to perform operations. The operations include receiving an input bit string. The operations include processing each bit of the input bit string sequentially to generate a cumulative hash matrix by: selecting a first generator matrix A when a current bit is zero; selecting a second generator matrix B when the current bit is one and a cookie state is inactive; selecting a third generator matrix C when the current bit is one and the cookie state is active; and multiplying the cumulative hash matrix by the selected generator matrix. The operations include transitioning the cookie state to active upon detecting a pattern of three consecutive one bits in the input bit string. The operations include transitioning the cookie state to inactive upon detecting a pattern of three consecutive zero bits in the input bit string. The operations include outputting the cumulative hash matrix as a cryptographic hash of the input bit string. The first generator matrix A, the second generator matrix B, and the third generator matrix C are 2×2 matrices over a finite field [symbol] .

According to other aspects of the present disclosure, the system may include one or more of the following features. The first generator matrix A may be

$$( \begin{matrix}1 & 2 \\ 0 & 1\end{matrix} ) ,$$

the second generator matrix B may be

$$( \begin{matrix}1 & 0 \\ 2 & 1\end{matrix} ) ,$$

and the third generator matrix C may be

$$( \begin{matrix}2 & 1 \\ 1 & 1\end{matrix} ) .$$

The operations may further include, when amending a previously hashed bit string with an additional bit string, padding the previously hashed bit string with three zero bits, hashing the additional bit string to produce an additional hash matrix, and multiplying a hash of the previously hashed bit string by the additional hash matrix to produce a hash of an amended bit string. The processor may be configured to compute the cumulative hash matrix using between 2(n−1) and 6(n−1) addition operations in [symbol] for an input bit string of length n. The finite field [symbol] may be defined by a prime p having 256 bits or 512 bits.

According to another aspect of the present disclosure, a non-transitory computer-readable medium storing instructions is provided. The instructions, when executed by a processor, cause the processor to perform operations. The operations include receiving an input bit string to be hashed. The operations include maintaining a cookie state that transitions between an inactive state and an active state based on bit patterns in the input bit string. The operations include for each bit in the input bit string: mapping the bit to one of three generator matrices A, B, or C based on a value of the bit and a current cookie state, wherein zero bits map to generator matrix A, one bits map to generator matrix B when the cookie state is inactive, and one bits map to generator matrix C when the cookie state is active; and accumulating a hash value by multiplying a current hash matrix by the mapped generator matrix. The operations include activating the cookie state when three consecutive one bits are detected. The operations include deactivating the cookie state when three consecutive zero bits are detected. The operations include outputting the accumulated hash value as a 2×2 matrix over a finite field [symbol] .

According to other aspects of the present disclosure, the non-transitory computer-readable medium may include one or more of the following features. The generator matrix A may be

$$( \begin{matrix}1 & 2 \\ 0 & 1\end{matrix} ) ,$$

the generator matrix B may be

$$( \begin{matrix}1 & 0 \\ 2 & 1\end{matrix} ) ,$$

and the generator matrix C may be

$$( \begin{matrix}2 & 1 \\ 1 & 1\end{matrix} ) .$$

The operations may further include verifying that no collisions exist for input bit strings having lengths less than log_{2.618}p where p is a prime defining the finite field [symbol] . The operations may further include processing the input bit string in parallel by dividing the input bit string at occurrences of three consecutive zero bits and combining partial hash results through matrix multiplication.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a cryptographic hash system, according to aspects of the present disclosure.

FIG. 2 illustrates a block diagram of a parallel hash processing system, according to aspects of the present disclosure.

FIG. 3 illustrates a flowchart of a method for cryptographic hashing using a Cayley hash function with cookies, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Prior work introduced the general concept of Cayley hash functions, such as the Zémor hash and the Tillich-Zémor hash, but were shown to be insecure because they used only two generators. Subsequent variations employing different pairs of generators were proposed, but most of those designs were also demonstrated to be vulnerable to collision-finding or preimage attacks. One such later approach utilized the same generator matrices employed in the present Cayley-based hashing framework.

In contrast to these two-generator constructions, embodiments of the present inventive concept discloses a hash function that introduces a third generator, drawing inspiration from random-walk models with “cookies” on a Cayley graph of a three-generator semigroup. Incorporating cookies into the hashing protocol adds controlled variability to the generator-selection process, thereby reducing the feasibility of precomputation attacks and enhancing overall security.

In brief overview, the inventive concept provides a cryptographic hashing method that transforms an input bit string into a hash value by multiplying a sequence of 2×2 matrices in a deterministic yet state dependent manner. The method processes the input bit string from left to right, mapping each bit to one of three generator matrices—A, B, or C—based on the bit's value and a dynamically maintained cookie state.

For every 0 bit, the method selects a first matrix. For 1 bits, the selection depends on whether a “cookie” is active. Initially, the cookie state is inactive, and each 1 bit is hashed using a second matrix. When the hashing process encounters three consecutive 1 bits, the cookie state becomes active. While active, all subsequent 1 bits are hashed using a third matrix instead of the second matrix. The cookie state remains active until the method detects three consecutive 0 bits, at which point the cookie is deactivated and the hashing of 1 bits switches back to the second matrix. This bit to matrix mapping rule therefore adapts to patterns in the input string.

As each bit is processed, the selected matrix is multiplied into a cumulative product matrix over the finite field. After the final bit is hashed, the resulting 2×2 matrix serves as the hash output. This cookie triggered switching mechanism introduces structured variability into the hashing process while remaining fully deterministic, improving resistance to preimage and structural attacks compared to traditional two generator Cayley hash constructions.

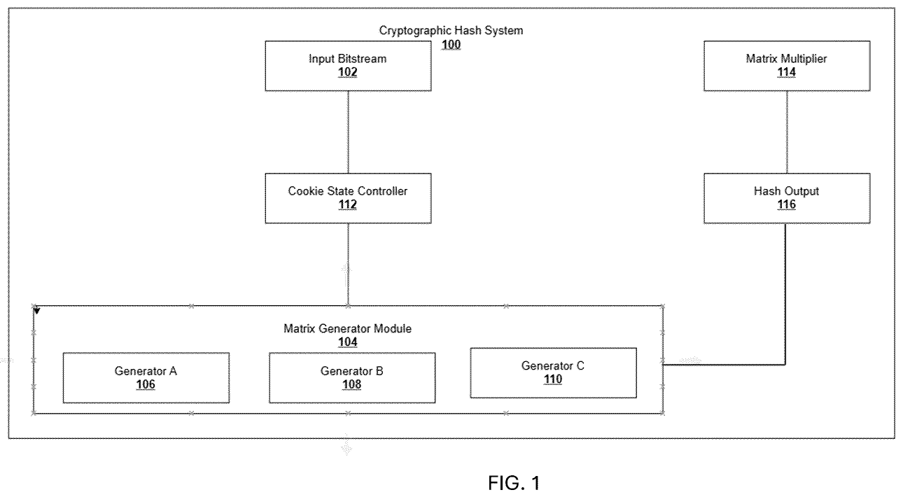

Referring to FIG. 1, a cryptographic hash system 100 may implement a Cayley hash function with cookies for enhanced data security. The cryptographic hash system 100 may utilize 2×2 matrices over a finite field [symbol] as a platform semigroup for hashing bit strings of arbitrary length. The finite field [symbol] may be defined by a prime number p, which in some cases may be a 256-bit prime or a 512-bit prime.

In some embodiments, the cryptographic hash system 100 employs a three-generator semigroup structure rather than a conventional two-generator approach used in prior Cayley hash functions. The three-generator structure may provide enhanced resistance to precomputation attacks by introducing variability in the matrix selection process during hashing operations.

The cryptographic hash system 100 may incorporate a concept of cookies borrowed from the theory of random walks in a random environment. A cookie is a temporary state that turns on when the hash function sees a special pattern in the input bits. For example, a cookie can be activated when the hash function sees three 1-bits in a row, and it changes how future 1-bits are hashed until the system later sees three 0-bits in a row. A cookie, in the context of the cryptographic hash system 100, may represent a location in a Cayley graph of the underlying semigroup where parameters of a random walk change in a specific manner.

The introduction of cookies may create an element of randomness that makes precomputation attacks less effective compared to conventional two-generator Cayley hash functions.

In some embodiments, the cryptographic hash system 100 may include an input bitstream 102 configured to receive bit strings of arbitrary length for hashing operations. The input bitstream 102 may accept binary data representing documents, messages, or other digital content to be processed by the cryptographic hash system 100. Unlike some conventional hash functions that require knowledge of the input length prior to processing, the input bitstream 102 may allow hashing to proceed incrementally as bits are received. The cryptographic hash system 100 may process an input bit string of arbitrary length of an input bitstream 102 by traversing the bit string from left to right and selecting appropriate generator matrices based on bit values and a current cookie state, i.e., active or inactive. The resulting hash value may be represented as a 2×2 matrix with entries in the finite field [symbol] . When p is a 256-bit prime, the hash output may have a size of up to 1024 bits, which corresponds to four matrix entries each having up to 256 bits.

As depicted in FIG. 1, a cookie state controller 112, matrix generator module 104, matrix multiplier 114, and hash output 116 collectively implement the cryptographic hash function, which is shown as a coordinated system of functional modules rather than a single monolithic block. In various embodiments, the cryptographic hash system 100 may be implemented in dedicated hardware circuitry, in software executed by one or more processors, or in a combination of hardware and software operating together within a computing device. The described modules including the cookie state controller 112, matrix generator module 104, matrix multiplier 114, and hash output 116 thus represent functional components realized through tangible computing machinery rather than an abstract mathematical concept.

The cookie state controller 112 is connected to the input bitstream 102. The cookie state controller 112 may monitor the input bitstream 102 for specific bit patterns that trigger state transitions during the hashing process. In some cases, as described above, the cookie state controller 112 may detect a pattern of three consecutive “1” bits, which may activate a cookie state. The cookie state controller 112 may also detect a pattern of three consecutive “0” bits, which may deactivate the cookie state and return the cryptographic hash system 100 to a default operating mode. The cookie state controller 112 may maintain a current state indicator that determines which generator matrix is selected for hashing “1” bits at any given point during processing. When the cookie state is inactive, “1” bits may be hashed using a first generator matrix. When the cookie state is active, “1” bits may be hashed using a different generator matrix. The cookie state controller 112 may provide state information to other components of the cryptographic hash system 100 to coordinate matrix selection.

As further shown in FIG. 1, the cryptographic hash system 100 may include a matrix generator module 104 connected to the cookie state controller 112. The matrix generator module 104 may contain three generator matrices used for hashing individual bits of the input bitstream 102. The matrix generator module 104 may include a generator A 106, a generator B 108, and a generator C 110.

The generator A 106 may provide a first 2×2 matrix used for hashing “0” bits regardless of the cookie state. In some embodiments, the generator A 106 may be defined as

$$A = ( \begin{matrix}1 & 2 \\ 0 & 1\end{matrix} ) .$$

The generator B 108 may provide a second 2×2 matrix used for hashing “1” bits when the cookie state is inactive. In some cases, the generator B 108 may be defined as

$$B = ( \begin{matrix}1 & 0 \\ 2 & 1\end{matrix} ) .$$

The generator C 110 may provide a third 2×2 matrix used for hashing “1” bits when the cookie state is active. In some cases, the generator C 110 may be defined as

$$C = ( \begin{matrix}2 & 1 \\ 1 & 1\end{matrix} ) .$$

These matrices are not limited to the entries shown in these embodiments, so other elements may equally apply.

The generator A 106, the generator B 108, and the generator C 110 may together generate a free semigroup over the integers. The semigroup generated by the generator A 106, the generator B 108, and the generator C 110 may be free, meaning that no non-trivial relations exist between products of the generators. The free semigroup property may provide a mathematical foundation for collision resistance in the cryptographic hash system 100.

The cryptographic hash system 100 may include a matrix multiplier 114 connected to the matrix generator module 104. The matrix multiplier 114 may perform sequential matrix multiplication operations to compute a cumulative hash value as bits from the input bitstream 102 are processed. The matrix multiplier 114 may receive selected matrices from the generator A 106, the generator B 108, or the generator C 110 based on the current bit value and the state information from the cookie state controller 112.

The matrix multiplier 114 may perform multiplication operations over the finite field [symbol] . In some cases, the matrix multiplier 114 may compute products using addition operations without requiring multiplication operations in [symbol] due to the structure of the generator matrices. For an input bit string having n bits, the matrix multiplier 114 may perform 5(n−1) additions in [symbol] to compute the hash value.

The cryptographic hash system 100 may include a hash output 116 connected to the matrix multiplier 114. The hash output 116 may provide the final hash value as a 2×2 matrix with entries in the finite field [symbol] . The hash output 116 may represent a cryptographic fingerprint of the input bitstream 102 that satisfies collision resistance, preimage resistance, and second preimage resistance properties.

The cryptographic hash system 100 may utilize generator matrices derived from base matrices that generate a free semigroup. A base matrix X may be defined as

$$X = ( \begin{matrix}1 & 1 \\ 0 & 1\end{matrix} )$$

and a base matrix Y may be defined as

$$Y = ( \begin{matrix}1 & 0 \\ 1 & 1\end{matrix} ) .$$

The base matrix X and the base matrix Y may generate a free semigroup over the integers, which is a well-established result in semigroup theory.

The generator A 106 may be defined in terms of the base matrix X as A=X². Computing the square of the base matrix X yields

$$A = ( \begin{matrix}1 & 2 \\ 0 & 1\end{matrix} ) .$$

The generator B 108 may be defined in terms of the base matrix Y as B=Y². Computing the square of the base matrix Y yields

$$B = ( \begin{matrix}1 & 0 \\ 2 & 1\end{matrix} ) .$$

The generator C 110 may be defined as the product of the base matrix X and the base matrix Y, expressed as C=XY. Computing the product of the base matrix X and the base matrix Y yields

$$C = ( \begin{matrix}1 & 1 \\ 0 & 1\end{matrix} ) ( \begin{matrix}1 & 0 \\ 1 & 1\end{matrix} ) = ( \begin{matrix}2 & 1 \\ 1 & 1\end{matrix} ) .$$

The semigroup generated by the generator A 106, the generator B 108, and the generator C 110 over the integers [symbol] may be a free semigroup. The free semigroup property may arise from the observation that none of the three words X², Y², and XY is a prefix of any other word among the three. When none of a set of words in a free semigroup is a prefix of any other word in the set, no semigroup relations may exist between such words. The absence of semigroup relations between the generator A 106, the generator B 108, and the generator C 110 may provide that distinct products of the generators correspond to distinct matrices over the integers [symbol] .

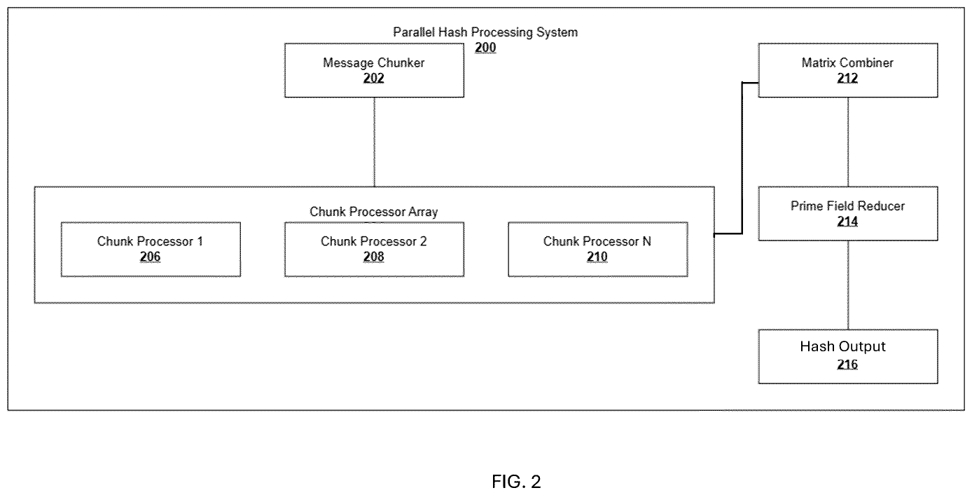

Referring to FIG. 2, a parallel hash processing system 200 may facilitate efficient computation of hash values for long bit strings by utilizing the matrix-based hashing operations performed by the cryptographic hash system 100 shown in FIG. 1. In this embodiment, the system of FIG. 2 builds upon the hashing pipeline of FIG. 1 and extends it into a parallel architecture, employing chunk-splitting logic and multiple processing units to compute partial hash results concurrently before combining them into a final hash value.

The parallel hash processing system 200 may utilize an associativity property expressed as H(XYZ)=H(XY)H(Z)=H(X)H(YZ) for any bit strings X, Y, and Z. The parallel hash processing system 200 may also utilize a homomorphic property expressed as H(XY)=H(X)H(Y), where XY represents concatenation of bit strings X and Y.

With continued reference to FIG. 2, the homomorphic property H(UV)=H(U)H(V) may hold for arbitrary bit strings U and V under specific conditions. The homomorphic property may hold when a rightmost occurrence of a substring 111 in U is followed by a substring 000 within U. The homomorphic property may also hold when concatenation of U and V does not create a new substring 111 that was not present in either U or V individually. For example, if U=011 and V=1001, the concatenation UV=0111001 may contain a substring 111 that was not a substring of U or V, which may affect the homomorphic property.

The parallel hash processing system 200 may include a segmentation module 202, also referred as a “message chunker,” that is configured to divide input messages into multiple segments suitable for parallel processing. In some embodiments, the same incoming data 102 of FIG. 1 can be first received and split by the segmentation module 202 into segments at safe boundaries (e.g., occurrences of 000), and each segment is then hashed by parallel “chunk processors” that perform the same operations as the FIG. 1 pipeline on their respective pieces. The segmentation module 202 may identify locations within the input message where the bit string may be split while preserving the homomorphic property. For parallel computation of a hash of a bit string W, the segmentation module 202 may split the bit string W at an occurrence of a substring 000. The segmentation module 202 may designate a prefix U that ends with the substring 000 and a suffix V that follows the substring 000. When the bit string W is split in this manner, the hash of W may be computed as H(W)=H(U)H(V), enabling parallel computation of H(U) and H(V) before combining the results through matrix multiplication.

The parallel hash processing system 200 may include a chunk processor array 204 connected to the segmentation module 202. The chunk processor array 204 may contain multiple processing units configured to handle divided message segments simultaneously. The chunk processor array 204 may enable scalable parallel processing by distributing computational workload across multiple processing units operating concurrently.

The chunk processor array 204 may include a chunk processor 1 206, a chunk processor 2 208, and a chunk processor N 210. The chunk processor 1 206, the chunk processor 2 208, and the chunk processor N 210 may represent a scalable array of parallel processing units, where N indicates an arbitrary number of processing units that may be employed based on the length of the input message and available computational resources. Each of the chunk processor 1 206, the chunk processor 2 208, and the chunk processor N 210 may independently process an assigned message segment by applying matrix operations based on bit values within that segment.

The chunk processor 1 206 may receive a first segment of the input message from the segmentation module 202 and compute a matrix product corresponding to that segment. The chunk processor 1 206 may traverse the assigned segment from left to right, selecting generator matrices based on bit values and cookie state conditions applicable to that segment. The chunk processor 2 208 may receive a second segment of the input message and perform analogous matrix operations on the second segment independently of the chunk processor 1 206. The chunk processor N 210 may receive an Nth segment of the input message and compute a corresponding matrix product for that segment.

Each of the chunk processor 1 206, the chunk processor 2 208, and the chunk processor N 210 may maintain local state information for cookie state transitions within the respective assigned segment. When segments are divided at occurrences of the substring 000, each of the chunk processor 1 206, the chunk processor 2 208, and the chunk processor N 210 may begin processing with the cookie state initialized to inactive, as the substring 000 resets the cookie state.

The parallel hash processing system 200 may include a matrix combiner 212 connected to the chunk processor 1 206, the chunk processor 2 208, and the chunk processor N 210. The matrix combiner 212 may receive processed matrix outputs from the chunk processor 1 206, the chunk processor 2 208, and the chunk processor N 210 upon completion of segment processing. The matrix combiner 212 may combine the processed matrix outputs through matrix multiplication to produce a unified result representing the hash of the complete input message.

The matrix combiner 212 may perform matrix multiplication operations in a sequential order corresponding to the original ordering of segments within the input message. For segments processed by the chunk processor 1 206, the chunk processor 2 208, and the chunk processor N 210, the matrix combiner 212 may compute a product of the form M₁·M₂· . . . ·M_{N}, where M₁ represents the output of the chunk processor 1 206, M₂ represents the output of the chunk processor 2 208, and M_{N} represents the output of the chunk processor N 210. The associativity of matrix multiplication may allow the matrix combiner 212 to combine partial results in various orders while producing the same final result.

The parallel hash processing system 200 may include a prime field reducer 214 connected to the matrix combiner 212. The prime field reducer 214 may perform modular reduction operations over the finite field [symbol] to constrain combined matrix values within defined field parameters. The prime field reducer 214 may reduce each entry of the combined matrix modulo the prime p to produce matrix entries within the range from 0 to p−1.

The prime field reducer 214 may perform modular reduction after the matrix combiner 212 completes combination of processed outputs. In some cases, the prime field reducer 214 may perform intermediate modular reductions during matrix multiplication operations within the matrix combiner 212 to prevent growth of intermediate values beyond computational limits. The prime field reducer 214 may utilize properties of modular arithmetic to maintain computational efficiency during reduction operations.

The parallel hash processing system 200 may include a hash output module 216 connected to the prime field reducer 214. The hash output 216 may represent the output hash value generated by the parallel hash processing system 200 after processing of the input message through the chunk processor array 204, the matrix combiner 212, and the prime field reducer 214. The hash output 216 may be expressed as a 2×2 matrix with entries in the finite field [symbol] , providing a cryptographic representation of the input message suitable for data integrity verification, message authentication, and other cryptographic applications.

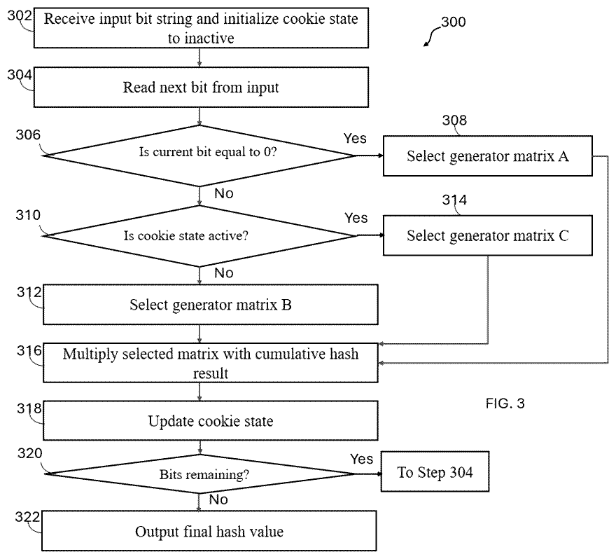

Referring to FIG. 3, a method 300 for cryptographic hashing using a Cayley hash function with cookies may be performed by a computing device executing instructions stored in memory to process input bit strings through selective matrix-based operations determined by bit values and cookie-state conditions. The method 300 may be carried out by one or more processors of the cryptographic hash system 100 described with reference to FIG. 1—or by other suitably configured computing hardware—by sequentially reading bits, updating a cookie state maintained in electronic memory, selecting corresponding generator matrices, and multiplying those matrices using finite-field arithmetic circuits or processor-implemented routines to generate a cumulative hash matrix.

The method 300 begins with a step 302 of receiving an input bit string of arbitrary length and initializing a cookie state to inactive. At step 302, the input bit string may be stored in a buffer or memory location accessible for sequential processing, namely, so that a processor may access the bits sequentially in order. The cookie state may be represented by a state variable or flag that indicates whether subsequent “1” bits should be hashed using the generator B 108 or the generator C 110. Initializing the cookie state to inactive at step 302 may establish that “1” bits encountered at the beginning of processing are hashed using the generator B 108 until a cookie pattern is detected.

The method 300 may next proceed to a step 304 of reading the next bit from the input string from left to right. At step 304, a current bit position indicator may advance to the next unprocessed bit in the input bit string. The bit at the current position may be retrieved for evaluation in subsequent steps of the method 300. Processing bits from left to right at step 304 may correspond to traversing the input bit string in a sequential manner consistent with the order in which the bits appear in the original input.

The method 300 may proceed to a decision diamond 306 of determining whether the current bit is equal to 0. At step 306, the bit value retrieved at step 304 may be compared against the value 0 to determine which generator matrix should be selected for the current bit. The determination at decision diamond 306 may represent a branching point in the method 300 where different processing paths are followed based on the bit value.

If the current bit is equal to 0 at step 306, the method 300 may proceed to a step 308 of selecting generator matrix A. At step 308, the generator A 106 may be selected as the matrix to be used for the current bit regardless of the cookie state. The generator A 106 may be defined as

$$A = ( \begin{matrix}1 & 2 \\ 0 & 1\end{matrix} ) .$$

and may be applied to all “0” bits encountered during processing of the input bit as string. Selection of the generator A 106 at step 308 may be independent of whether the cookie state is active or inactive, as the cookie state may affect matrix selection for “1” bits rather than “0” bits.

If the current bit is not equal to 0 at step 306, the method 300 may proceed to a decision diamond 310 of determining whether the cookie state is active. At decision diamond 310, the state variable representing the cookie state may be evaluated to determine which generator matrix should be selected for the current “1” bit. The determination at decision diamond 310 may distinguish between two different processing paths for “1” bits based on whether a cookie pattern has been previously detected in the input bit string.

If the cookie state is not active at decision diamond 310, the method 300 may proceed to a step 312 of selecting generator matrix B. At step 312, the generator B 108 may be selected as the matrix to be used for the current “1” bit. The generator B 108 may be defined as

$$B = ( \begin{matrix}1 & 0 \\ 2 & 1\end{matrix} )$$

and may be applied to “1” bits when the cookie state is inactive. The cookie state may be inactive at the beginning of processing and may remain inactive until a pattern of three consecutive “1” bits is detected.

If the cookie state is active at decision diamond 310, the method 300 may proceed to a step 314 of selecting generator matrix C. At step 314, the generator C 110 may be selected as the matrix to be used for the current “1” bit. The generator C 110 may be defined as

$$C = ( \begin{matrix}2 & 1 \\ 1 & 1\end{matrix} )$$

and may be applied to “1” bits when the cookie state is active. The cookie state may become active upon detection of three consecutive “1” bits and may remain active until a pattern of three consecutive “0” bits is detected.

The method 300 may process an example bit string 11001110101100011 to illustrate matrix selection based on bit values and cookie state conditions. Processing the example bit string from left to right, the first bit “1” may be hashed to matrix B since the cookie state is initially inactive. The second bit “1” may also be hashed to matrix B. The third bit “0” may be hashed to matrix A. The fourth bit “0” may be hashed to matrix A. The fifth bit “1” may be hashed to matrix B. The sixth bit “1” may be hashed to matrix B. The seventh bit “1” may be hashed to matrix B, and detection of three consecutive “1” bits at positions five, six, and seven may activate the cookie state.

Continuing with the example bit string, the eighth bit “0” may be hashed to matrix A. The ninth bit “1” may be hashed to matrix C since the cookie state is now active. The tenth bit “0” may be hashed to matrix A. The eleventh bit “1” may be hashed to matrix C. The twelfth bit “1” may be hashed to matrix C. The thirteenth bit “0” may be hashed to matrix A. The fourteenth bit “O” may be hashed to matrix A. The fifteenth bit “0” may be hashed to matrix A, and detection of three consecutive “0” bits at positions thirteen, fourteen, and fifteen may deactivate the cookie state. The sixteenth bit “1” may be hashed to matrix B since the cookie state is now inactive. The seventeenth bit “1” may be hashed to matrix B. The complete bit string 11001110101100011 may thus be hashed to the matrix product BBAABBBACACCAAABB.

The cookie trigger pattern of three consecutive “1” bits may be replaced with other switch patterns between the generator B 108 and the generator C 110. Alternative switch patterns may provide flexibility in cookie positioning within the Cayley graph of the underlying semigroup. The deactivation pattern of three consecutive “0” bits may similarly be replaced with other patterns that reset the cookie state. Selection of alternative switch patterns may affect the distribution of cookies within the Cayley graph and may influence resistance to precomputation attacks.

Following matrix selection at step 308, step 312, or step 314, the method 300 may proceed to a step 316 of multiplying the selected matrix with a cumulative hash result. At step 316, the generator matrix selected in the preceding step may be multiplied with an accumulated matrix product representing the hash computation performed on all previously processed bits. For the first bit processed in the input bit string, the cumulative hash result may be initialized to an identity matrix or to the selected generator matrix itself. For subsequent bits, step 316 may compute a new cumulative hash result by performing matrix multiplication of the existing cumulative hash result with the newly selected generator matrix.

The matrix multiplication at step 316 may be performed over the finite field Fₚ, where p is a prime number. The multiplication operation at step 316 may involve computing products and sums of matrix entries followed by reduction modulo p. Due to the structure of the generator matrices, the matrix multiplication at step 316 may be accomplished using addition operations in [symbol] without requiring multiplication operations in [symbol] . The cumulative hash result after step 316 may be a 2×2 matrix with entries in the finite field [symbol] .

The method 300 may proceed to a step 318 of updating the cookie state. At step 318, the cookie state may be evaluated and modified based on recent bit patterns detected in the input bit string. The cookie state may activate upon detecting three consecutive “1” bits in the input bit string. When three consecutive “1” bits are detected, step 318 may set the cookie state to active, which may cause subsequent “1” bits to be hashed using the generator C 110 rather than the generator B 108.

The cookie state may deactivate upon detecting three consecutive “0” bits in the input bit string. When three consecutive “0” bits are detected, step 318 may set the cookie state to inactive, which may cause subsequent “1” bits to be hashed using the generator B 108 rather than the generator C 110. Step 318 may maintain a count or buffer of recent bits to facilitate detection of the three consecutive “1” bit pattern and the three consecutive “0” bit pattern.

At step 318, the cookie state update may occur after the matrix multiplication at step 316 has been completed for the current bit. The cookie state determined at step 318 may affect matrix selection for subsequent bits processed in the method 300. The cookie state may remain unchanged at step 318 when neither the three consecutive “1” bit pattern nor the three consecutive “0” bit pattern is detected at the current position in the input bit string.

The method 300 may proceed to a step 320 of determining whether more bits remain in the input. At step 320, the current bit position indicator may be compared against the total length of the input bit string to determine whether additional bits remain to be processed. Step 320 may represent a loop control point in the method 300 that determines whether processing should continue with additional bits or proceed to output generation.

If more bits remain at step 320, the method 300 may return to step 304 to read the next bit from the input string. The loop formed by step 304, step 306, step 308, decision diamond 310, step 312, step 314, step 316, step 318, and step 320 may repeat for each bit in the input bit string until all bits have been processed. Each iteration of the loop may update the cumulative hash result and the cookie state based on the current bit value and detected bit patterns.

If no more bits remain at step 320, the method 300 may proceed to a step 322 of outputting the final hash value. At step 322, the cumulative hash result computed through successive matrix multiplications at step 316 may be provided as the output of the method 300. The final hash value output at step 322 may be a 2×2 matrix with entries in the finite field [symbol] . The final hash value may represent a cryptographic fingerprint of the input bit string that may be used for data integrity verification, message authentication, digital signatures, and other cryptographic applications.

The final hash value output at step 322 may have a size determined by the prime p used in the finite field [symbol] . When p is a 256-bit prime, the final hash value may have a size of up to 1024 bits, corresponding to four matrix entries each having up to 256 bits. When p is a 512-bit prime, the final hash value may have a size of up to 2048 bits. The method 300 may terminate after step 322 completes output of the final hash value.

As further noted above, certain embodiments may employ a particular set of generator matrices that provide desirable algebraic and security properties. In such embodiments, the recommended matrices are:

$$A = ( \begin{matrix}1 & 2 \\ 0 & 1\end{matrix} ) , B = ( \begin{matrix}1 & 0 \\ 2 & 1\end{matrix} ) , C = ( \begin{matrix}2 & 1 \\ 1 & 1\end{matrix} )$$

Proposition 1. The semigroup generated by the matrices A, B, and C over [symbol] is free. These matrices may be derived from the base matrices:

$$X = ( \begin{matrix}1 & 1 \\ 0 & 1\end{matrix} ) , Y = ( \begin{matrix}1 & 0 \\ 1 & 1\end{matrix} )$$

It is well known that X and Y generate a free semigroup. Then, A=X², B=Y², C=XY. Note that none of the three words X², Y², XY is a prefix of any other. In that case, it is known (and easy to see) that there are no semigroup relations between such words.

Thus, if matrices A, B, C are considered over [symbol] , there cannot be any collisions in the corresponding hash function unless a bit string that is hashed is long enough for at least one of the entries in a product of matrices to become larger than p. This is why it is important to determine the growth of the largest entry in a product of n matrices, as a function of n (described below).

If one wants to amend an already hashed bit string X by another bit string Y without re-hashing the whole bit string XY, one can do a minor padding of X. Specifically, three zeros would have to be added at the end of X. Because of the rules at Step 2 of the hashing protocol, this will reset hashing elements to the original pair (A, B) of matrices. Therefore, the homomorphic property H(XY)=H(X)H(Y) will be preserved, so that one would have to hash just Y and then multiply H(X) by H(Y). Thus, another essential feature is that when an already hashed document is amended, one does not have to hash the whole amended document all over again but rather hash just the amended part and then multiply the result by the hash of the unmodified part of the original document.

In general, for two arbitrary bit strings U and V, the homomorphic property H(UV)=H(U)H(V) will hold if (1) the rightmost occurrence in U of the substring 111 is followed (perhaps not immediately) by a substring 000; (2) concatenation of U and V does not create a new substring 111, as in e.g. U=011, V=1001, where UV=0111001 has a substring 111 that was not a substring of U or V. This is sufficient if one wants to parallelize computation of the hash of a given bit string W. Find an occurrence of the substring 000, and denote the prefix of W that ends with this 000 by U, and the remaining suffix by V. Then H(W)=H(U)H(V). In some embodiments, one can use other “switches” between matrices B and C, instead of the substrings 111 and 000.

The following is an examination of the general problem of determining how the largest entry in a product of n matrices grows as the word length increases. This analysis is motivated by the fact that slower growth in these matrix entries corresponds to longer provable lower bounds on collision length in the associated hash function, as discussed previously in Sections 2 and 3. In the discussion that follows, A, B, C are matrices over [symbol] .

Problem 1. What is the maximal possible entry of a matrix w(A, B, C), as a function of the word length n=|w|, over all words w of length n?

Problem 2. What is the maximal entry of a matrix ω(A, B, C), where w is a generic word of length n?

The problem with Problem 2 is that it is not easy to formalize “generic” since the probability of matrices B or C appearing in any particular place in a product of n matrices is difficult to estimate. However, Problem 2 can be studied experimentally.

The growth of entries in 3-generator semigroups of matrices has not been studied before, to the best of our knowledge. By comparison, the 2-generator case has been studied fairly well. Below is a summary of what is known about the growth of entries in 2-generator semigroups of matrices over [symbol] , i.e., in matrices of the form ω(A, B) for various popular instances of A and B.

$$D e n o t e A ( k ) = ( \begin{matrix}1 & k \\ 0 & 1\end{matrix} ) , B ( m ) = ( \begin{matrix}1 & 0 \\ m & 1\end{matrix} )$$

In L. Bromberg, V. Shpilrain, A. Vdovina, “Navigating in the Cayley graph of SL2(Fp) and applications to hashing,” Semigroup Forum 94 (2017), 314-324, incorporated by reference herein in its entirety, it was proved that the maximum growth in products of n matrices of the form ω(A(k), B(k)) for integers k≥1 is achieved by the words ω(A(1),

$${B ( 1 ) )}^{\frac{n}{2}}$$

(assuming that n is even).

As one would expect, growth of the entries in matrices ω(A(1), B(1)) is the slowest among all ω(A(k), B(k)) for integers k≥1. The largest entries in the corresponding matrices (A(1),

$${B ( 1 ) )}^{\frac{n}{2}} are O ( {( \frac{3}{2} + \frac{\sqrt{5}}{2} )}^{n} ) .$$

Note that

$$\frac{3}{2} + \frac{\sqrt{5}}{2} \approx 1.618 .$$

For matrices (A(2), B(2)), the largest entries are in the matrices (A(2),

$${B ( 2 ) )}^{\frac{n}{2}}$$

and their magnitude is O((1+\sqrt{2})ⁿ). This implies that the girth of the corresponding Cayley graph (over [symbol] ) is O(log_{1+\sqrt{2}}n). Note that 1+2≈2.41. Incidentally, this is the best known lower bound for the girth in this particular case. In fact, in L. Bromberg incorporated by reference above, an exact expression for the largest entries was obtained:

$$( \frac{1}{2} + \frac{1}{\sqrt{8}} ) {( 1 + \sqrt{2} )}^{n} + ( \frac{1}{2} - \frac{1}{\sqrt{8}} ) {( 1 - \sqrt{2} )}^{n} .$$

This implies, in particular, that if p is on the order of 2²⁵⁶, then there are no collisions of the form u(A(2), B(2))=v(A(2), B(2)) if both the words u and v are of length less than 203≈log_{2.41} 2²⁵⁶=256 log_{2.41} 2. To date, there have been no successful attacks reported against the hash function based on the matrices A(2) and B(2).

The pair of matrices A=A(2) and B=B(−2) give the minimum growth rate of the largest entry in ω(A(k), B(m)) among all |k|, |m|≥2. According to computer experiments, the largest (by the absolute value) entries occur in

$${( ABBA )}^{\frac{m}{4}}$$

and these entries are O((\sqrt{2+\sqrt{3}})ⁿ)| Note that \sqrt{2+\sqrt{3}}≈1.93. Generically, i.e., in a random product of length n of the matrices A(2) and B(2) (where each factor is A(2) or B(2) with probability 1/2) the largest entry grows approximately as (1.9)ⁿ. This was determined experimentally, by averaging over 1000 products of 1000 matrices. Also, generically, the largest entry in a random product of length n of the matrices A(2) and B(−2) grows approximately as (1.68)ⁿ. Again, this was determined experimentally, by averaging over 1000 products of 1000 matrices.

With regard to growth in ω(A, B, C), the growth questions (Problems 1 and 2) are relevant to the particular Cayley hash function above. Recall that in this situation A=X², B=Y², C=XY, where

$$X = ( \begin{matrix}1 & 1 \\ 0 & 1\end{matrix} ) , Y = ( \begin{matrix}1 & 0 \\ 1 & 1\end{matrix} )$$

Proposition 2. The bit string 11111 . . . yields hash matrices with the fastest growing entries, among hash matrices of all bit strings of the same length.

Proof. The hash matrix of such a bit string of length n is B³Cⁿ⁻³. Neglecting the B³ factor, here are powers of C=XY, so powers of C are alternating products of the matrices X and Y. The latter are known to give the fastest growth among all ω(X, Y) as described elsewhere in this specification.

Throwing in some 0 bits in this bit string will result in throwing in some X² matrices in the matrix product, and then one will have subfactors like XYX² and/or X²XY=X³Y In either case, X and Y will no longer be alternating in a product, so the growth of the entries in a product matrix will be slower.

Alternatively, if, after throwing in some 0 bits one gets three zeros in a row, hashing the 1 bit will be switched to the matrix B=Y², and then there are subfactors that are products of matrices X² and Y², so again X and Y will not be alternating in such a product, therefore again the growth of the entries in a product matrix will be slower than it is in the matrices that hash a sequence of 1 bits only.

Thus, the maximum growth is that of the entries of the matrices Cⁿ=(XY)ⁿ, and this is known to be on the order of

$$O ( {( \frac{3}{2} + \frac{\sqrt{5}}{2} )}^{2 n} ) = O ( {( \frac{7}{2} + \frac{3}{2} \sqrt{5} )}^{n} ) .$$

Note that

$$\frac{7}{2} + \frac{3 \sqrt{5}}{2} \approx 2.618 ,$$

This implies that there are no collisions H(u)=H(v) in the hash function H if both bit strings u and v are of length less than log_{2.618} p. In particular, if p is on the order of 2²⁵⁶, then there are no collisions if both bit strings u and v are of length less than 184=256 log_{2.618} 2.

With the particular choice of matrices A, B, C as in Section 3, computation of the hash is very efficient. Indeed, computing the hash H(u) of a given bit string u of length n takes (n−1) matrix multiplications where each time one multiplies by one of the matrices A, B, or C.

In any of the matrices A, B, C, one of the entries is 2 and other entries are 0 or 1. When multiplying by a matrix, there is no need to do any multiplications of numbers since multiplying a number x by 2 is the same as adding x to itself.

With this in mind, multiplying by a matrix A or B requires 2 additions of numbers in [symbol] , and multiplying by a matrix C requires 3 additions of numbers in [symbol] . Therefore, computing H(u) requires no multiplications and between 2(n−1) and 3(n−1) additions in [symbol] . Furthermore, if it is necessary, after adding up two numbers, to reduce the result modulo p, this will require just one subtraction of p. Thus, computing the hash H(u) of a given bit string u of length n requires no multiplications and between 2(n−1) and 6(n−1) additions/subtractions of 256-bit integers.

In the experiments, 1000 bit strings of length 10⁶ bits were hashed to average the running times of the hashes. The average time to hash 10⁶ bits was about 0.25 sec (with suggested parameters, see Section 7), without any optimization. The version without any cookies, i.e., the Cayley hash function that uses just the matrices A and B, is not much faster. Specifically, it takes 0.22 sec to hash 10⁶ bits with that hash function. Thus, the overhead from using cookies is about 14%.

Collision resistance claims for Cayley hash functions are typically based on satisfactory lower bounds for the girth of the relevant Cayley graph. Our lower bound is logarithmic in p, which is consistent with other proposals of Cayley hash functions that use matrices over the field [symbol] or its extensions. Of course, the base of the logarithm matters, too, which is why more specific lower bounds on the girth (as in our Section 4) are important.

Embodiments of a method of estimating the girth is described herein. It gives very good results in some cases; in particular, for the girth of the Cayley graph corresponding to the pair of matrices (A(2), B(2)), our lower bound is tighter than lower bounds obtained by other techniques. However, this has a flip side: unless some of the entries in a matrix ω(A(2), B(2)) are larger than p, this ω(A(2), B(2)) is an element of the free semigroup in SL₂( [symbol] ) generated by A(2) and B(2). In that case, there is an efficient algorithm described by A. Chorna, K. Geller, V. Shpilrain, “On two-generator subgroups of SL2(Z), SL2(Q), and SL2(R),” J.Algebra 478 (2017), 367-381, incorporated by reference in its entirety, that recovers the word ω, i.e., in the context of the corresponding Cayley hash function it recovers a preimage of the hash. The reason why this algorithm is efficient is that, given a matrix W=ω(A(2), B(2)), exactly one of the matrices WA⁻¹ and WB⁻¹ has a smaller sum of the absolute values of the entries than the matrix W does.

With embodiments of the hash function, this algorithm typically will not be feasible even in case of relatively short bit strings (of a couple of hundred bits). This is because in this situation it is not true that, given a matrix W=ω(A, B, C), exactly one of the matrices WA⁻¹ WB⁻¹, and WC⁻¹ has a smaller sum of the absolute values of the entries than the matrix W does. Therefore, at least at some steps the attacker would have to explore more than one option, so the number of steps can be exponential in the number of bits in a bit string that the attacker wants to recover.

With a brute force attack (trying out, one at a time, all 2ⁿ bit strings of length n until a preimage is found), the number of trials is on the order of 2ⁿ. Thus, for preimage security, the length of a bit string to be hashed has to be at least t, where t is the security parameter. Currently, it is recommended that t≥256.

Finally, to date, there were no successful attacks reported against the Cayley hash function, call it H₁, based on the two matrices,

$$A = ( \begin{matrix}1 & 2 \\ 0 & 1\end{matrix} ) , B = ( \begin{matrix}1 & 0 \\ 2 & 1\end{matrix} ) .$$

The Cayley hash function in accordance with embodiments of the present inventive concept, call it H₂, based on the matrices A, B, and

$$C = ( \begin{matrix}2 & 1 \\ 1 & 1\end{matrix} ) ,$$

is at least as preimage resistant as H₁ is, in the following sense: if there is an algorithm (deterministic or not) for recovering preimage of H₂(u) for any bit string u of length n, then the same algorithm will recover preimage of H₁(u) for any bit string u of length n. This is because if a bit string u does not include a substring of three “1” bits in a row, then H₁(u) is just the same as H₂(u).

In some embodiments, for p in [symbol] , for matrices that hash individual bits, the following is suggested:

$$A = ( \begin{matrix}1 & 2 \\ 0 & 1\end{matrix} ) , B = ( \begin{matrix}1 & 0 \\ 2 & 1\end{matrix} ) , C = ( \begin{matrix}2 & 1 \\ 1 & 1\end{matrix} ) .$$

A hash function should generate outputs as random as possible. See NIST Statistical Test Suite NIST Statistical Test Suite, 2010. http://csrc.nist.gov/groups/ST/toolkit/rng/documentation_software.html to evaluate the randomness of the outputs in binary form from the proposed hash function with suggested parameters. The NIST Statistical Test Suite is a package that includes 15 types of tests, each with a suitable metric needed to investigate the degree of randomness for binary sequences produced by cryptographic random generators. In these tests, a set of statistical tests for randomness are used for detecting deviations of a binary sequence from randomness. Even though no statistical test can certify if a (pseudo) random generator is suitable for usage in a specific cryptographic application, the NIST tests may be useful as a first step in that direction.

The NIST statistical tests are formulated to test the null hypothesis H₀ that the sequence being tested is random. Thus, the alternative hypothesis H_{A} is that the sequence being tested is non-random. For each NIST test and sequence tested, a test statistic value is calculated from the sample of bits.

The P-value (or probability value) is the probability of getting a sample statistic with the test value or a more extreme sample statistic in the direction of the alternative hypothesis H_{A} under the assumption that the null hypothesis H₀ is true. It is a measure of strength of the evidence against the null hypothesis (randomness). Specifically, if the P-value is ≥α (NIST suite has α set to 0.01=1%), the conclusion is that the sequence is random, otherwise, it is non-random.

The following are deviations from randomness that each test in the NIST Suite detects in binary sequences:
Frequency test—Too many zeroes or ones.
Block frequency test—Too many zeros or ones within a block
Runs test—Large (small) total number of runs indicates that the oscillation in the bit string is too fast (too slow).
Longest runs of ones test—Deviation of the distribution of long runs of ones.
Rank test—Deviation of the rank distribution from a corresponding random sequence, due to periodicity.
Discrete Fourier Transform (spectral) test—Periodic features in the bit stream. Non-overlapping template matchings test—Too many occurrences of non-periodic templates.
Overlapping template matchings test—Too many occurrences of m-bit runs of ones.
Universal statistical test—Compressibility (regularity).
Linear complexity test—Deviation from the distribution of the linear complexity for finite length (sub)strings.
Serial test—Non-uniform distribution of m-length words. Similar to the approximate entropy test.
Approximate entropy test—Non-uniform distribution of m-length words. Small values of ApEn(m) imply strong regularity.
Cumulative sums test—Too many zeroes or ones at the beginning of the sequence.
Random excursions test—Deviation from the distribution of the number of visits of a random walk to a certain state.
Random excursion variant test—Deviation from the distribution of the total number of visits (across many random walks) to a certain state.

For each test, there is a recommended minimum size for the binary streams being tested. See A. Rukhin, J. Soto, J. Nechvatal, E. Barker, S. Leigh, M. Levenson, D. Banks, A. Heckert, J. Dray, S. Vo, and others, “A statistical test suite for random and pseudorandom number generators for cryptographic applications. NIST special publication,” 2010 incorporated by reference in its entirety. If one wishes to apply all the tests in the suite, a minimum of 10⁶ in length is recom-mended for the binary strings tested. Also, the P-values processed by the NIST tests use approximation, so the more sequences are tested the more accurate results will be obtained.

SageMath by W. A. Stein and others. SageMath, the Sage Mathematics Software System (Version 10.2), The Sage Developers, 2023. https://www.sagemath.org, was applied to generate the hash values in binary form. Random primes of order 2²⁵⁶ and 2⁵¹² were generated for the modulos of the hash function and also random binary strings as inputs of length 10⁶ bits. These inputs were padded with 000 to reset the matrices (see above and finally, the corresponding matrix products were calculated. The hash values consist of the concatenated matrix entries in binary form with lengths of 1024 and 2048 bits, respectively. Here, data is analyzed for the modulus p of the order 2²⁵⁶

and 2⁵¹².

Tables 1 and 2 present the statistical properties of the hash values as reported by the NIST test suite, obtained after processing 100 binary sequences of length 10⁶.

TABLE 1
NIST Suite Results for a Prime of Order 2²⁵⁶

| Number | Statistical test | P-value | Pass rate |
|---|---|---|---|
| 1 | Frequency | 0.678686 | 98/100 |
| 2 | Block frequency | 0.003447 | 100/100 |
| 3 | Cumulative sums 1 | 0.224821 | 98/100 |
| 4 | Cumulative sums 2 | 0.719747 | 97/100 |
| 5 | Runs | 0.021999 | 100/100 |
| 6 | Longest runs of ones | 0.289667 | 99/100 |
| 7 | Rank | 0.935716 | 99/100 |
| 8 | FFT | 0.045675 | 98/100 |
| 9 . . . 156 | Non-overlapping | 0.471367¹ (mean) | 98.92/100² (mean) |
| | templates | | |
| 157 | Overlapping template | 0.304126 | 100/100 |
| 158 | Universal | 0.657933 | 99/100 |
| 159 | Approximate entropy | 0.224821 | 98/100 |
| 160 . . . 167 | Random excursions | 0.533178³(mean) | 50.75/51⁴(mean) |
| 168 . . . 185 | Random excursions | 0.344685⁵(mean) | 50.78/51⁶(mean) |
| | variant | | |
| 186 | Serial 1 | 0.514124 | 98/100 |
| 187 | Serial 2 | 0.401199 | 99/100 |
| 188 | Linear complexity | 0.249284 | 99/100 |

¹ 148 tests with a minimum of 0.006196 and a maximum of 0.99425.
² 148 tests with a minimum of 96 and a maximum of 100.
³8 tests with a minimum of 0.032923 and a maximum of 0.964295.
⁴8 tests with a minimum of 50 and a maximum of 51.
⁵18 tests with a minimum of 0.048716 and a maximum of 0.719747.
⁶18 tests with a minimum of 50 and a maximum of 51.

TABLE 2
NIST Suite Results for a Prime of Order 2⁵¹²

| Number | Statistical test | P -value | Pass rate |
|---|---|---|---|
| 1 | Frequency | 0.071177 | 98/100 |
| 2 | Block frequency | 0.202268 | 99/100 |
| 3 | Cumulative sums 1 | 0.304126 | 97/100 |
| 4 | Cumulative sums 2 | 0.224821 | 97/100 |
| 5 | Runs | 0.759756 | 98/100 |
| 6 | Longest runs of ones | 0.366918 | 100/100 |
| 7 | Rank | 0.090936 | 100/100 |
| 8 | FFT | 0.798139 | 99/100 |
| 9 . . . 156 | Non-overlapping | 0.518710¹ (mean) | 99.09/100² (mean) |
| | templates | | |
| 157 | Overlapping template | 0.637119 | 96/100 |
| 158 | Universal | 0.23681 | 100/100 |
| 159 | Approximate entropy | 0.062821 | 99/100 |
| 160 . . . 167 | Random excursions | 0.680366³(mean) | 61.38/62⁴(mean) |
| 168 . . . 185 | Random excursions | 0.394883⁵(mean) | 61.5/62⁶(mean) |
| | variant | | |
| 186 | Serial 1 | 0.334538 | 97/100 |
| 187 | Serial 2 | 0.678686 | 100/100 |
| 188 | Linear complexity | 0.249284 | 96/100 |

¹ 148 tests with a minimum of 0.004301 and a maximum of 0.996335.
²148 tests with a minimum of 96 and a maximum of 100.
³8 tests with a minimum of 0.437274 and a maximum of 0.862344.
⁴8 tests with a minimum of 60 and a maximum of 62.
⁵18 tests with a minimum of 0.039244 and a maximum of 0.985035.
⁶18 tests with a minimum of 61 and a maximum of 62.

NIST suggests considering data to be random if and only if the sequence/sequences pass both the uniformity test of P-values and the test of the proportion of passing sequences.

According to the NIST documentation, a pass rate of 96% is acceptable. This corresponds to a minimum pass rate for each statistical test, except the random excursion (variant) test, which is approximately 96 for a sample size of 100 binary sequences. The minimum pass rate for the random excursion (variant) test is approximately 48 for a sample size of 51 binary sequences with p of order 2²⁵⁶, and approximately 59 for a sample size of 62 binary sequences with p of order 2⁵¹².

The following primes p were used to generate hash values tested with the NIST Statistical Test Suite.

### Prime of Order 2²⁵⁶:

Decimal form:
112130193533856809970443000822829414572933780556534369189742044710202716867 171

### Prime of Order 2⁵¹².

Decimal form:
125967099140123813315752220780255508336665456536865562994120730587591125391 967925091696994227751978218691778592631951849571530599067583803022383297237 74073

In sum, the foregoing describes a Cayley hash function H that employs random walks (with cookies) on the Cayley graph of a 3-generator (instead of the usual 2-generator) semigroup of 2×2 matrices over [symbol] . If p is a 256-bit prime, then the size of H(u) for any bit string u is 1024 bits. If the bit string u has n bits, then computing H(u) (with the recommended choice of matrices A, B, C) requires no multiplications and 5(n−1) additions in [symbol] .

In some embodiments, there are provably no collisions H(u)=H(v) in the hash function H if both bit strings u and v are of length less than

$${log}_{\frac{7}{2} + \frac{3 \sqrt{5}}{2}} p \approx {log}_{2.618} p .$$

In particular, if p is a 256-bit prime, then there are no collisions if both bit strings u and v are of length less than 184=256 log_{2.618} 2. If p is a 512-bit prime, then there are no collisions if both bit strings are of length less than 368, etc. Note that

$${log}_{\frac{7}{2} + \frac{3 \sqrt{5}}{2}} p$$

is just a provable lower bound for the girth of the relevant Cayley graph; the actual birth might be much larger. Embodiments of the hash function has successfully passed all the pseudo-randomness tests in the NIST Statistical Test Suite.

A number of implementations have been described. Nevertheless, it will be understood that various modifications may be made without departing from the spirit and scope of the disclosure. Accordingly, other implementations are within the scope of the following claims.

1. A method for hashing a bit string, the method comprising:
receiving, by a processor, an input bit string;
maintaining a cookie state that transitions between an inactive state and an active state based on detection of predetermined bit patterns in the input bit string;
mapping each bit of the input bit string sequentially, wherein:
when the bit is a zero bit, selecting a first generator matrix A;
when the bit is a one bit and the cookie state is inactive, selecting a second generator matrix B;
when the bit is a one bit and the cookie state is active, selecting a third generator matrix C;
multiplying a cumulative hash matrix by the selected generator matrix to produce an updated cumulative hash matrix, wherein the first generator matrix A, the second generator matrix B, and the third generator matrix C are 2×2 matrices over a finite field;
activating the cookie state upon detecting a first predetermined bit pattern in the input bit string;
deactivating the cookie state upon detecting a second predetermined bit pattern in the input bit string; and
outputting the updated cumulative hash matrix as a hash value of the input bit string.

2. The method of claim 1, wherein the first predetermined bit pattern comprises three consecutive one bits and the second predetermined bit pattern comprises three consecutive zero bits.

3. The method of claim 2, wherein the first generator matrix A is defined as A=[[1, 2], [0, 1]], the second generator matrix B is defined as B=[[1, 0], [2, 1]], and the third generator matrix C is defined as C=[[2, 1], [1, 1]].

4. The method of claim 3, wherein the finite field is defined by a prime number p having 256 bits.

5. The method of claim 1, further comprising dividing the input bit string into a plurality of segments at boundaries defined by a second predetermined bit pattern, computing a partial hash matrix for each segment in parallel using the steps of claim 1, and combining the partial hash matrices through matrix multiplication to produce the hash value.

6. The method of claim 1, wherein the first generator matrix, the second generator matrix, and the third generator matrix are 2×2 matrices that generate a free semigroup over integers.

7. The method of claim 6, further comprising:
dividing the input bit string into a plurality of chunks at boundaries where the second predetermined bit pattern occurs;
computing a partial hash matrix for each chunk in parallel; and
combining the partial hash matrices through matrix multiplication to produce the hash value.

8. The method of claim 1, wherein multiplying the cumulative hash matrix by the selected generator matrix is performed using addition operations without multiplication operations in the finite field.

9. The method of claim 8, wherein computing the hash value for the input bit string having n bits requires between 2(n−1) and 6(n−1) addition operations in the finite field.

10. The method of claim 1, further comprising:
when amending a previously hashed bit string with an additional bit string, padding the previously hashed bit string with the second predetermined bit pattern;
hashing the additional bit string to produce an additional hash matrix; and
multiplying a hash of the previously hashed bit string by the additional hash matrix to produce a hash of an amended bit string.

11. The method of claim 1, wherein the input bit string is processed from left to right.

12. A system for cryptographic hashing, comprising:
a memory storing instructions; and
a processor coupled to the memory and configured to execute the instructions to perform operations comprising:
receiving an input bit string;
processing each bit of the input bit string sequentially to generate a cumulative hash matrix by:
selecting a first generator matrix A when a current bit is zero;
selecting a second generator matrix B when the current bit is one and a cookie state is inactive;
selecting a third generator matrix C when the current bit is one and the cookie state is active; and
multiplying the cumulative hash matrix by the selected generator matrix;
transitioning the cookie state to active upon detecting a pattern of three consecutive one bits in the input bit string;
transitioning the cookie state to inactive upon detecting a pattern of three consecutive zero bits in the input bit string; and
outputting the cumulative hash matrix as a cryptographic hash of the input bit string, wherein the first generator matrix A, the second generator matrix B, and the third generator matrix C are 2×2 matrices over a finite field.

13. The system of claim 12, wherein the first generator matrix A is [[1, 2], [0, 1]], the second generator matrix B is [[1, 0], [2, 1]], and the third generator matrix C is [[2, 1], [1, 1]].

14. The system of claim 13, wherein the operations further comprise:
when amending a previously hashed bit string with an additional bit string, padding the previously hashed bit string with three zero bits;
hashing the additional bit string to produce an additional hash matrix; and
multiplying a hash of the previously hashed bit string by the additional hash matrix to produce a hash of an amended bit string.

15. The system of claim 12, wherein the processor is configured to compute the cumulative hash matrix using between 2(n−1) and 6(n−1) addition operations in the finite field for an input bit string of length n.

16. The system of claim 15, wherein the finite field is defined by a prime p having 256 bits or 512 bits.

17. A non-transitory computer-readable medium storing instructions that, when executed by a processor, cause the processor to perform operations comprising:
receiving an input bit string to be hashed;
maintaining a cookie state that transitions between an inactive state and an active state based on bit patterns in the input bit string;
for each bit in the input bit string:
mapping the bit to one of three generator matrices A, B, or C based on a value of the bit and a current cookie state, wherein zero bits map to generator matrix A, one bits map to generator matrix B when the cookie state is inactive, and one bits map to generator matrix C when the cookie state is active; and
accumulating a hash value by multiplying a current hash matrix by the mapped generator matrix;
activating the cookie state when three consecutive one bits are detected;
deactivating the cookie state when three consecutive zero bits are detected; and
outputting the accumulated hash value as a 2×2 matrix over a finite field.

18. The non-transitory computer-readable medium of claim 17, wherein the generator matrix A is [[1, 2], [0, 1]], the generator matrix B is [[1, 0], [2, 1]], and the generator matrix C is [[2, 1], [1, 1]].

19. The non-transitory computer-readable medium of claim 18, wherein the operations further comprise verifying that no collisions exist for input bit strings having lengths less than log base 2.618 of p, where p is a prime defining the finite field.

20. The non-transitory computer-readable medium of claim 17, wherein the operations further comprise processing the input bit string in parallel by dividing the input bit string at occurrences of three consecutive zero bits and combining partial hash results through matrix multiplication.
